(19) United States
(12) Patent Application Publication
(10) Pub. No.: US 2021/0027334 A1
(43) Pub. Date: Jan. 28, 2021

(54) Vehicle Communication System

(71) Applicant: OLA ELECTRIC MOBILITY PRIVATE LIMITED, Bengaluru (IN)

(72) Inventors: Parth Suthar, Bangalore (IN); Sudhir Singh Mor, Ahmedabad (IN); Shreeyash Salunke, Pune (IN); Arjun S, Bengaluru (IN); Subramanian Ramakrishnan, Bangalore (IN); Subhojit Basu, Bangalore (IN); Akshay P, Davanagere (IN); Arijit Dey, Agartala (IN); Mihul Prakash, Kalyanpur (IN); Manu Chaudhary, Ghaziabad (IN); Poorva Mankad, Bangalore (IN); Ravi Shankar Singh Ahirwar, Bhopal (IN); Varun A. M, Chitradurga district (IN)

(73) Assignee: OLA ELECTRIC MOBILITY PRIVATE LIMITED, Bengaluru (IN)

(21) Appl. No.: 16/935,765

(22) Filed: Jul. 22, 2020

(30) Foreign Application Priority Data
Jul. 23, 2019 (IN) 201941029816

(51) Int. Cl. G06Q 30/02; H04W 4/021; H04W 4/48; H04W 4/90; G06Q 50/30; G09F 21/04; G09F 27/00

(52) U.S. Cl. CPC G06Q 30/0265; H04W 4/021; H04W 4/48; G09F 27/004; G06Q 50/30; G09F 21/042; G09F 27/00; H04W 4/90

(57) ABSTRACT

A vehicle-mounted communication system is provided. The communication system includes a communication device. The communication device includes at least a plurality of displays that are mounted on top of a vehicle. Each display includes a smoky acrylic covering for hiding one or more dead pixels. Based on real-time status of the vehicle, a driver of the vehicle, or a passenger therein, the communication device obtains targeted content and displays the targeted content on the plurality of displays for communicating relevant information to various prospective passengers for their rides or other near-by individuals who can offer help in case of any emergency.

### CROSS-RELATED APPLICATIONS

This application claims priority of Indian Non-Provisional Application No. 201941029816, filed Jul. 23, 2019, the contents of which are incorporated herein by reference.

### FIELD

Various embodiments of the disclosure relate generally to communication systems. More specifically, various embodiments of the disclosure relate to communication of targeted content to outside users of a vehicle by means of one or more communication devices mounted on the vehicle.

### BACKGROUND

Generally, passengers avail various public and private transportation services for making trips to and from work places, or when the passengers are engaged in personal activities. In modern cities, vehicle transit systems play an important role by providing vehicle services to the passengers to travel to their desired destinations. Although, there is an advancement in online ways of booking rides for travelling, a majority of the passengers prefer offline ways of travelling between two or more locations. However, the offline ways of travelling include a few shortcomings.

When a prospective passenger attempts to hire an approaching vehicle (for example, a 3-wheeler autorickshaw) for a ride, the passenger has to primarily determine whether the approaching vehicle is available for the ride or not. In such a scenario, the passenger may have to peep inside the approaching vehicle to determine whether the approaching vehicle is occupied by another passenger or is available for the ride. Alternatively, the passenger signals a driver of the approaching vehicle a desire to hire the approaching vehicle for the ride. When the approaching vehicle is available for the ride, the passenger communicates a desired destination to the driver. Based on the communicated desired destination, there is a possibility in which the driver may deny to offer ride services to the passenger because of personal preferences. In such a scenario, the passenger has to further wait for another vehicle and repeat the same procedures for getting the ride to the desired destination. Such ways of finding suitable rides are completely luck-based and are not desirable to various prospective passengers as it can cause unnecessary delays. Furthermore, such ways of finding the suitable rides are completely tiring and frustrating for the various prospective passengers.

In light of the foregoing, there exists a need for a technical and reliable solution that overcomes the above-mentioned problems and facilitates effective and efficient way of communicating desirable information to various prospective passengers.

### SUMMARY

A communication system for a vehicle is provided substantially as shown in, and described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an environment in which various embodiments of the disclosure are practiced;

FIG. 2 is a block diagram that illustrates a communication device of the environment of FIG. 1, in accordance with an exemplary embodiment of the disclosure;

FIG. 3 is a block diagram that illustrates a transportation server of the environment of FIG. 1, in accordance with an exemplary embodiment of the disclosure;

FIG. 4A is a diagram that illustrates a top view of a vehicle of the environment of FIG. 1, in accordance with an exemplary embodiment of the disclosure;

FIG. 4B is a diagram that illustrates a side view of displays of the communication device, in accordance with an exemplary embodiment of the disclosure;

FIG. 4C is a diagram that illustrates a front view of the vehicle including a display of the communication device, in accordance with an exemplary embodiment of the disclosure;

FIG. 5 is a block diagram that illustrates a user interface rendered on a driver device of a driver of the vehicle, in accordance with an exemplary embodiment of the disclosure; and

FIG. 6 is a block diagram that illustrates a system architecture of a computer system for communicating targeted content to one or more users, in accordance with an exemplary embodiment of the disclosure.

### DETAILED DESCRIPTION

Certain embodiments of the disclosure may be found in a disclosed apparatus for communicating targeted content to one or more users such as prospective passengers, rescue entities, or the like. Exemplary aspects of the disclosure provide a communication method and system for a vehicle. The method includes one or more operations that are executed by the communication system to facilitate effective and efficient way of communicating desirable information to various prospective passengers. The communication system includes a communication device that is communicatively coupled to at least one of a driver device of a driver of the vehicle or a transportation server associated with a vehicle service provider. The vehicle service provider is a ride-hailing service provider that offers on-demand vehicle services to one or more passengers in a geographical region. The communication device may include a plurality of displays that are mounted on an outer surface of the vehicle, facing forward and backward for the best all-round visibility. Each display may include a smoky acrylic covering for hiding one or more dead pixels associated with each display, which in turn enhances aesthetic view of each display. The communication device may further include a processor that is communicatively coupled to each of the plurality of displays. The processor may be configured to receive targeted content associated with the vehicle from at least one of the driver device or the transportation server. In another embodiment, the targeted content may be automatically retrieved from a local database or a remote database in an event of one or more anomalies detected by one or more sensors installed in the vehicle or one or more safety concerns triggered by the driver or a passenger of the vehicle. Thereafter, the processor may be configured to display the targeted content on each of the plurality of displays.

In an embodiment, the targeted content may indicate at least one of a vehicle availability status of the vehicle for a ride, a seat availability status of a seat in the vehicle for the ride, a ride discount for the ride, a change in a ride fare for the ride, a vehicle rating of the vehicle, vehicle information of the vehicle, and allocation information of the vehicle. The targeted content may further indicate a destination location of the driver, along with one or more intermediate locations from a current location of the driver of the vehicle to the destination location. The targeted content may further indicate at least one of a location preference of the driver, a ride type preference of the driver, a route preference of the driver, a driver rating of the driver, a custom status message of the driver, and driver information of the driver. The targeted content may further indicate at least one of a weather forecast and a pollution status associated with the current location of the vehicle. The targeted content may further indicate at least an emergency incident associated with the vehicle, the driver, or the passenger of the vehicle.

In an embodiment, the processor may be further configured to display the targeted content on the plurality of displays in a plurality of languages, respectively. The display of the targeted content in the plurality of languages may be automatically switched between the plurality of displays based on a defined time duration. The processor may determine the plurality of languages based on at least location information of the vehicle and a language preference of the driver. In an embodiment, a service application running on the driver device may be used by the driver to communicate one or more preferences to the communication device. The one or more preferences may be associated with at least one of the targeted content and one or more languages preferred by the driver for displaying the targeted content.

In an embodiment, the communication system further includes one or more emergency switches in the vehicle that are communicatively coupled to the communication device for communicating the emergency incident when the driver or the passenger presses the one or more emergency switches. In an embodiment, the communication system further includes one or more sensors in the vehicle that are communicatively coupled to the communication device for communicating the emergency incident when the one or more sensors automatically detect the one or more anomalies associated with at least one of the vehicle, the driver, or the passenger.

In an embodiment, the communication system further includes a first set of audio devices for communicating an audio output corresponding to the targeted content. The first set of audio devices may be mounted on the outer surface of the vehicle. In an embodiment, the processor may be configured to control activation or deactivation of the plurality of displays and the first set of audio devices based on one or more inputs provided by the driver. The driver may provide the one or more inputs by using the service application running on the driver device.

Thus, the communication method and system of the present disclosure facilitates effective and efficient communication of the targeted content to various prospective passengers or other individuals who are outside the vehicle. The communication device of the disclosure facilitates enhanced mobility experience for drivers, passengers, and vehicles around. The communication device facilitates increased aesthetic view of each display. Furthermore, the communication device has been positioned on the top of each vehicle, facing forward and backward for best all-round visibility. Furthermore, a prospective passenger may easily determine whether an approaching vehicle is available for hiring or not. The disclosure further facilitates hassle free denials of rides when a driver of the approaching vehicle has own location preferences for new rides.

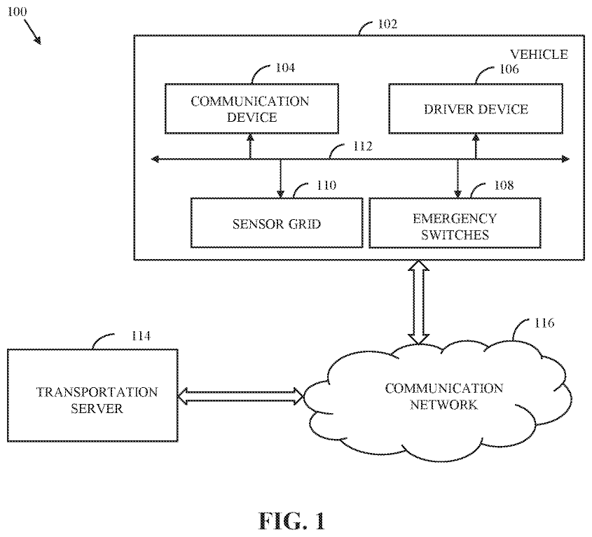

FIG. 1 is a block diagram that illustrates an environment 100 in which various embodiments of the disclosure are practiced. The environment 100 includes a vehicle 102 including a communication device 104, a driver device 106, a set of emergency switches 108 (hereinafter, “the emergency switches 108”), and a sensor grid 110. The communication device 104, the driver device 106, the emergency switches 108, and the sensor grid 110 communicate with each other via a communication bus 112. The environment 100 further includes a transportation server 114. In an embodiment, the communication device 104, the driver device 106, the emergency switches 108, the sensor grid 110, and the transportation server 114 may communicate with each other via a communication network 116.

The vehicle 102 is a mode of transport that is deployed by a vehicle service provider (such as OLA) to offer on-demand vehicle services to passengers. Examples of the vehicle 102 may include, but are not limited to, an automobile, an autorickshaw, a bus, a car, and a bike. The vehicle 102 may be an electric vehicle, a non-electric vehicle, a semi-electric vehicle, an autonomous vehicle, or the like. The vehicle 102 may be associated with one of various categories of vehicles facilitated by the vehicle service provider for offering the on-demand vehicle services to the passengers. In one example, the vehicle 102 is a micro-category vehicle, i.e., a compact hatchback vehicle. In another example, the vehicle 102 is a mini-category vehicle, i.e., a regular hatchback vehicle. In another example, the vehicle 102 is a prime-category vehicle, i.e., a prime sedan vehicle, a prime play vehicle, a prime sport utility vehicle (SUV), or a prime executive vehicle. In another example, the vehicle 102 is a lux-category vehicle, i.e., a luxury vehicle. In another example, the vehicle 102 is a shared-ride vehicle. In an embodiment, the vehicle 102 may be used by its driver to offer rides to various passengers on individual-basis or sharing-basis. The driver of the vehicle 102 may register on an online ride-hailing service platform (facilitated by the vehicle service provider) and provide driver information and vehicle information for registration prior to offering rides to various passengers on individual-basis or sharing-basis. The vehicle service provider may be a ride-hailing service provider (such as OLA) that offers the on-demand vehicle services to the passengers in a geographical region, when the passengers initiate ride requests for the vehicle services in an online manner. The vehicle service provider may facilitate the online ride-hailing service platform on which drivers of various vehicles and the prospective passengers may connect with each other for providing and availing the vehicle services, respectively.

The communication device 104 may include suitable logic, circuitry, interfaces, and/or code, executable by the circuitry, that may be configured to perform one or more operations for communication of targeted content. The communication device 104 may be a computing device of the vehicle 102 that may be configured to communicate the targeted content to one or more prospective passengers who are waiting or looking for one or more rides. The communication device 104 may include one or more displays and/or audio devices for communicating the targeted content to the one or more prospective passengers. The communication device 104 may be the computing device that is communicatively coupled to the communication network 116 for performing one or more operations, such as receiving, processing, and communicating the targeted content associated with the vehicle 102. Various operations of the communication device 104 may be dedicated to execution of procedures, such as, but not limited to, programs, routines, or scripts stored in its memory for supporting its applied applications. Examples of the communication device 104 may include, but are not limited to, a personal computer, a laptop, or a network of computer systems. The communication device 104 may be realized through various web-based technologies such as, but not limited to, a Java web-framework, a .NET framework, a PHP (Hypertext Preprocessor) framework, or any other web-application framework. The communication device 104 may be further realized through various embedded technologies such as, but not limited to, microcontrollers or microprocessors that are operating on one or more operating systems such as Windows, Android, Unix, Ubuntu, or the like.

In one embodiment, the communication device 104 may be configured to communicate with at least one of the driver device 106 or the transportation server 114 via the communication network 116, and facilitate communication of requisite information (e.g., the targeted content) by means of the one or more displays and/or audio devices. In another embodiment, the communication device 104 may be configured to communicate with at least one of other communication devices or driver devices of other vehicles associated with the vehicle service provider via the communication network 116, and facilitate communication of requisite information (e.g., the targeted content) by means of the one or more displays and/or audio devices.

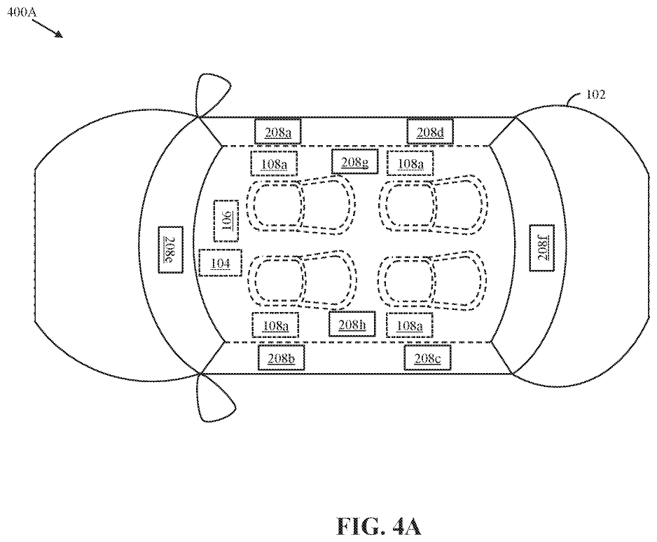

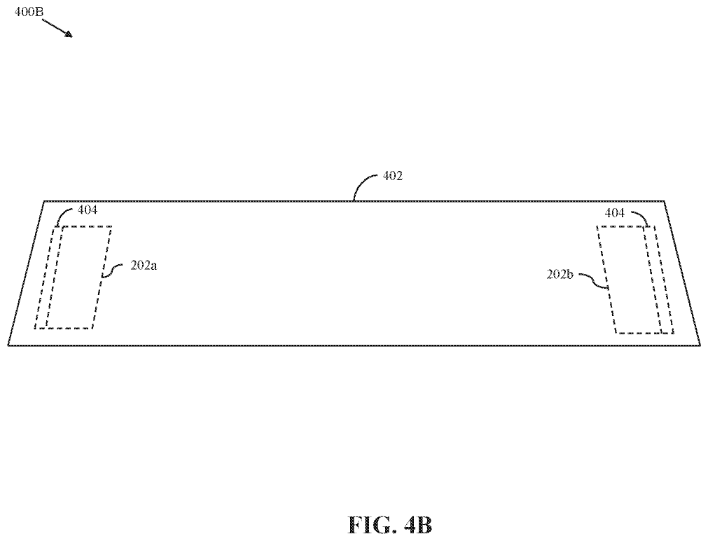

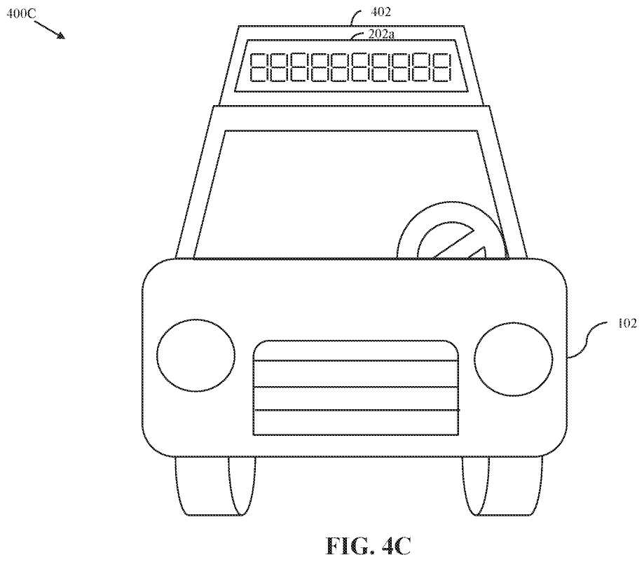

In an embodiment, the communication device 104 may include the one or more displays (as shown in FIG. 4B). The one or more displays (hereinafter, “the displays”) may be mounted on an outer surface of the vehicle 102. For example, the displays may be mounted on top of the vehicle 102 (as shown in FIGS. 4B and 4C). Each display is a light emitting diode (LED) display and is made with a dense 3 mm (millimeter) pitch LED display. Each display is enclosed in a casing that is designed to avoid direct sunlight on its display. Furthermore, each display is covered with a smoky acrylic coating that hides one or more dead pixels on its display, which in turn improves aesthetic view of each display.

In an embodiment, the communication device 104 may also include one or more audio devices (as shown in the FIG. 4A). The one or more audio devices (hereinafter, “the audio devices”) may be mounted on an outer surface of the vehicle 102. For example, the audio devices may be mounted on top of the vehicle 102. An audio device may correspond to an audio speaker that is configured to output audio signals.

In an embodiment, the communication device 104 may be configured to communicate the targeted content by means of at least one of the displays and the audio devices. The targeted content is specific information that may be created or generated for a subset of general audience (such as the one or more prospective passengers) who prefer offline way of hailing vehicles for their rides or drivers who prefer to offer vehicle services to these passengers on their own preferences. The targeted content is unique because it is designed to elicit the specific information based on real-time preferences of the drivers or in-vehicle passengers. For example, the targeted content may indicate at least one of a vehicle availability status of the vehicle 102 for a ride, a seat availability status of a seat in the vehicle 102 for the ride, a ride discount for the ride, a change in a ride fare for the ride, a vehicle rating of the vehicle 102, vehicle information of the vehicle 102, and allocation information of the vehicle 102. The targeted content may further indicate a destination location of the driver of the vehicle 102, along with one or more intermediate locations from a current location of the driver of the vehicle 102 to the destination location. The targeted content may further indicate at least one of a location preference of the driver, a ride type preference of the driver, a route preference of the driver, a driver rating of the driver, a custom status message of the driver, and driver information of the driver. The targeted content may further indicate at least one of a weather forecast and a pollution status associated with the current location of the vehicle 102. The targeted content may further indicate at least an emergency incident associated with the vehicle 102, the driver, or a passenger of the vehicle 102. The targeted content may be communicated in one or more languages by means of at least one of the displays and the audio devices. The one or more languages may be determined based on at least location information of the vehicle 102 and one or more language preferences of the driver of the vehicle 102.

In an embodiment, the communication device 104 may be configured to enable the driver of the vehicle 102 to communicate the targeted content to the one or more prospective passengers (hereinafter, “the prospective passengers”). For example, the driver of the vehicle 102 may use a service application running on the driver device 106 to provide one or more preferences for the targeted content. The driver of the vehicle 102 may further use the service application to provide one or more preferences for one or more languages for communicating the targeted content by means of at least one of the displays and the audio devices of the communication device 104.

In an embodiment, the communication device 104 may be configured to receive the targeted content from the driver device 106 and display the targeted content on the displays that are mounted on the top of the vehicle 102. In another embodiment, the communication device 104 may be configured to receive the targeted content from the transportation server 114 and display the targeted content on the displays. In another embodiment, the communication device 104 may be configured to retrieve the targeted content from a local database (e.g., from its own memory) or a remote database (e.g., from a database server) and display the targeted content on the displays.

In an exemplary embodiment, the targeted content corresponds to an availability status of the vehicle 102 i.e., whether the vehicle 102 is available for hiring or not. In another exemplary embodiment, the targeted content corresponds to a ride-type preference of the driver of the vehicle 102 i.e., whether the vehicle 102 is available for hiring on individual-basis or sharing-basis. In another exemplary embodiment, the targeted content corresponds to a location preference of the driver of the vehicle 102. For example, the location preference may indicate a location where the driver wants to travel or is currently heading to from its current location. In another exemplary embodiment, the targeted content corresponds to a route preference of the driver of the vehicle 102. For example, the driver may wish to specify a preference for operating the vehicle 102 along a specific route such as an LBS road (Lal bahadur Shastri road in Mumbai, India). In another example, when the vehicle 102 is operated on sharing-basis, the driver may want to communicate that the vehicle 102 will be operating on an outer ring road (Bengaluru, India) so as to attract more passengers having destinations along the same route. In another exemplary embodiment, the targeted content corresponds to a change in a ride fare. For example, when the demand to a specific location is high, the driver may increase the ride fare for a ride to the specific location. In another example, when the demand to the specific location is less, the driver may decrease the ride fare for the ride to the specific location. In another exemplary embodiment, the targeted content corresponds to a custom status message (such as greetings) that the driver wants to convey to the prospective passengers. In another exemplary embodiment, the targeted content corresponds to a weather forecast (such as temperature, air pressure, humidity, rainfall, or the like), a pollution status (such as air quality), and the like. In one example, the weather forecast and the pollution status may be obtained from a third-party server associated with a meteorological or pollution department of a geographical region in which the driver is currently operating the vehicle 102. In another exemplary embodiment, the weather forecast and the pollution status may be obtained by means of the sensor grid 110 including various in-vehicle sensors (such as temperature sensors, humidity sensors, air pressure sensors, air pollution sensors, or the like) integrated with the vehicle 102. In another exemplary embodiment, the targeted content corresponds to a seat availability status of one or more seats in the vehicle 102. The seat availability status may be communicated when the driver is currently operating the vehicle 102 on sharing-basis. In one example, the driver may specify the seat availability status of each seat in the vehicle 102. In another example, the seat availability status of each seat may be automatically detected by means of the sensor grid 110 including various in-vehicle sensors (such as seat sensors) integrated with each seat. In another example, the seat availability status of each seat may be automatically detected by performing real-time image analysis of one or more images captured by one or more image-capturing devices of the vehicle 102. In another exemplary embodiment, the targeted content corresponds to a ride discount that is offered on a ride fare for availing a ride with the vehicle 102. For example, the driver may offer the reduced ride fare to each prospective passenger in a non-surge period such as, in the afternoon or in the midnight, to increase earnings. In another example, the vehicle service provider may offer the ride discount to each prospective passenger on its behalf. The ride discount may also vary based on a seat type of each seat in the vehicle 102. In another exemplary embodiment, the targeted content corresponds to driver information of the driver and vehicle information of the vehicle 102. For example, the driver information may include driver's name, driver's rating, driver's experience, or the like. The vehicle information may include vehicle's type, vehicle's features, vehicle's rating, or the like. In another exemplary embodiment, the targeted content corresponds to allocation information of the vehicle 102. For example, the allocation information may include passenger's details of a passenger who has booked the vehicle 102 for a ride. This enables the passenger to track the booked vehicle 102 easily based on the passenger's name displayed on the displays of the communication device 104. In another exemplary embodiment, the targeted content corresponds to an emergency message corresponding to the emergency incident associated with the vehicle 102, the driver, or any passenger therein. For example, the emergency message may indicate a break-down, a hijack, a robbery, a medical help, or the like.

The driver device 106 may include suitable logic, circuitry, interfaces, and/or code, executable by the circuitry, that may be configured to perform one or more operations for the communication. The driver device 106 may be a computing device that is communicatively coupled with the communication device 104 for performing one or more operations. For example, the driver of the vehicle 102 may use the driver device 106 to draft, edit, retrieve, and/or communicate the targeted content to the communication device 104. In an embodiment, the driver device 106 may be a device mounted within the vehicle 102, such as a vehicle head unit. In another embodiment, the driver device 106 may be a portable device (such as a mobile phone) of the driver of the vehicle 102. The driver device 106 may include the service application installed on it that is hosted by the transportation server 114.

Prior to communicating the targeted content, the driver of the vehicle 102 may use the service application running on the driver device 106 to register herself or himself as a driver on the online ride-hailing service platform associated with the vehicle service provider. The driver may provide registration details (for example, a login ID, a login password, a name, a mobile number, an email ID, or the like) to register with the vehicle service provider.

Upon successful registration, the driver may use the driver device 106 (i.e., the service application running on the driver device 106) to communicate the one or more preferences for the targeted content, such as the location preference, the route preference, the ride-type preference, the customer status message, or the like, to the communication device 104 or the transportation server 114. The driver may further use the driver device 106 to communicate the one or more preferences for the one or more languages for displaying the targeted content to the communication device 104 or the transportation server 114. The driver may further use the driver device 106 to update the one or more preferences (associated with the targeted content and the one or more languages) at any time before, during, or after a ride.

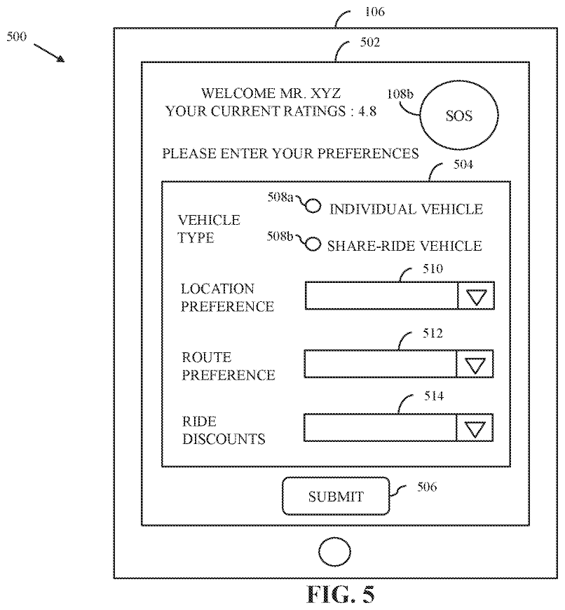

In an embodiment, the service application (running on the driver device 106) may be configured to facilitate an emergency SOS tab (as shown in FIG. 5) to the driver for initiating an emergency alarm in an event of an emergency-like situation. Based on triggering of the emergency SOS tab by the driver, the service application (or the driver device 106) may be configured to communicate an emergency control command to the communication device 104 for communicating the emergency message (e.g., “HELP”) by means of at least one of the displays and the audio devices.

Further, the driver device 106 may be communicatively connected to the sensor grid 110 and the one or more image-capturing devices (not shown) of the vehicle 102. In an embodiment, the vehicle 102 may include the sensor grid 110 including one or more sensors such as one or more pressure sensors integrated with each seat of the vehicle 102. The service application may be configured to receive sensor data from the one or more pressure sensors of each seat. Further, the service application may be configured to process the sensor data to determine the availability status of each seat in the vehicle 102. In another embodiment, the service application may be configured to receive image data from the one or more image-capturing devices and process the image data to determine the availability status of each seat in the vehicle 102. The service application may use one or more processing techniques, such as deep learning and image processing techniques, to process the sensor and image data and determine the availability status of each seat in the vehicle 102. In another embodiment, the service application may be configured to determine the availability status of each seat in the vehicle 102 based on comparison of a capacity of the vehicle 102 and current booking associated with the vehicle 102. For example, the capacity of the vehicle 102 is “6” when the vehicle 102 is an SUV. Considering, the vehicle 102 may be currently operating on sharing-basis and the current booking for the vehicle 102 is “4”. In such a scenario, the service application may determine the number of available seats in the vehicle 102 as “2”.

The emergency switches 108 may be electronic switches, mechanical switches, software-enabled switches, or any combination thereof that are installed in the vehicle 102 for performing one or more emergency-related operations. For example, the driver of the vehicle 102 or the passenger of the vehicle 102 may trigger an emergency switch of the emergency switches 108 for communicating an emergency control command to at least one of the communication device 104, the driver device 106, or the transportation server 114. The emergency control command may be indicative of the emergency incident associated with at least one of the vehicle 102, the driver, or the passenger. Examples of the emergency switches 108 include, but are not limited to, push button switches, levers, keys, knobs, or the like.

The sensor grid 110 may include suitable logic, circuitry, interfaces, and/or code, executable by the circuitry, that may be configured to perform one or more operations. In an embodiment, the sensor grid 110 may include the one or more sensors that are configured to sense or detect one or more respective signals or data, record the one or more respective signals or data, process the one or more respective signals or data, and/or communicate the one or more respective signals or data (hereinafter, “the sensor data”) to other devices or servers such as the communication device 104, the driver device 106, or the transportation server 114. The one or more sensors may be analog sensors, digital sensors, or any combination thereof. The sensor grid 110 may include the one or more sensors such as the one or more pressure sensors installed in each seat of the vehicle 102 for measuring the seat pressure. The seat pressure may be used to determine the availability status of each seat in the vehicle 102. The sensor grid 110 may further include the one or more sensors such as one or more location sensors for measuring real-time location (in terms of longitude, latitude, and altitude) of the vehicle 102. The sensor grid 110 may further include the one or more sensors such as one or more health sensors for measuring one or more health parameters of at least one of the vehicle 102, the driver, or the passenger. The one or more health sensors may further monitor the health conditions of at least one of the vehicle 102, the driver, or the passenger based on the one or more health parameters. Based on the monitoring, if the one or more health sensors automatically detect one or more anomalies associated with at least one of the vehicle 102, the driver, or the passenger, then the one or more health sensors (or the sensor grid 110) may communicate the emergency incident to at least one of the communication device 104, the driver device 106, or the transportation server 114. The sensor grid 110 may further include the one or more sensors, such as one or more temperature sensors, humidity sensors, air pressure sensors, or air pollution sensors, that are configured to measure and record the weather forecast and the pollution status. such as temperature, humidity, air pressure, air pollution, or the like, associated with the current location of the vehicle 102.

The transportation server 114 may include suitable logic, circuitry, interfaces, and/or code, executable by the circuitry, that may be configured to perform one or more operations corresponding to the communication of the targeted content by means of the communication device 104. The transportation server 114 may be a computing device, which may include a software framework, that may be configured to create the transportation server implementation and perform the various dedicated operations. The transportation server 114 may be realized through various web-based technologies, such as, but are not limited to, a Java web-framework, a .NET framework, a professional hypertext preprocessor (PHP) framework, a python framework, or any other web-application framework. The transportation server 114 may be further realized through various embedded technologies such as, but are not limited to, microcontrollers or microprocessors that are operating on one or more operating systems such as Windows, Android, Unix, Ubuntu, Mac OS, or the like. The transportation server 114 may also be realized as a machine-learning model that implements any suitable machine-learning techniques, statistical techniques, or probabilistic techniques. Examples of such techniques may include expert systems, fuzzy logic, support vector machines (SVM), Hidden Markov models (HMMs), greedy search algorithms, rule-based systems, Bayesian models (e.g., Bayesian networks), neural networks, decision tree learning methods, other non-linear training techniques, data fusion, utility-based analytical systems, or the like. Examples of the transportation server 114 may include, but are not limited to, a personal computer, a laptop, or a network of computer systems. The transportation server 114 may also be implemented as a cloud-based server.

In an embodiment, the transportation server 114 may be configured to store account profiles of all drivers, such as the driver of the vehicle 102, who are registered on the online ride-hailing service platform for providing the vehicle services to the passengers. Further, the transportation server 114 may be configured to store account profiles of all passengers who are registered on the online ride-hailing service platform for availing the vehicle services. The account profile of each driver or each passenger may include at least one of an account ID, a name, an email ID, a contact number, an address, a rating, an emergency contact detail, and the like.

Further, in an embodiment, the transportation server 114 may be configured to process various ride requests initiated by the passengers in the online manner for availing the vehicle services, and allocate an available vehicle (such as the vehicle 102, if available) to each passenger for a ride. The transportation server 114 may be further configured to receive at least one of driver data from the driver device 106 specified by the driver of the vehicle 102, the emergency control command (corresponding to the emergency incident) from the emergency switches 108, the sensor data (such as seat pressure data, location data, health data, or the like) from the sensor grid 110, or the like. Thereafter, the transportation server 114 may be configured to process the received data, generate the targeted content, and store the targeted content in its memory or the local or remote database. The transportation server 114 may be further configured to communicate the targeted content to the communication device 104 and control communication (e.g., display or audio output) of the targeted content by means of at least one of the displays and the audio devices. For example, the communication of the targeted content may be controlled based on the health condition of at least one of the vehicle 102, the driver, or any passenger therein. The communication of the targeted content may also be controlled based on the current availability and allocation status of the vehicle 102. The communication of the targeted content may also be controlled based on the one or more preferences specified by the driver of the vehicle 102.

In operation, the communication device 104 may be configured to receive the targeted content from the driver device 106. In another embodiment, the communication device 104 may be configured to receive the targeted content from the transportation server 114. In another embodiment, the communication device 104 may be configured to retrieve the targeted content from the local database (e.g., from its own memory) or the remote database (e.g., from a database server). The communication device 104 may retrieve the targeted content (for example, related to the emergency incident) from the local database or the remote database in an event of the emergency incident when the driver or the passenger of the vehicle 102 presses one or more emergency switches such as emergency switches 108. The communication device 104 may further retrieve the targeted content (for example, related to the emergency incident) from the local database or the remote database in an event of the emergency incident when the one or more sensors (i.e., the sensor grid 110) automatically detect the one or more anomalies with respect to at least one of the vehicle 102, the driver of the vehicle 102, or any passenger in the vehicle 102.

In an exemplary embodiment, the targeted content may include at least one of an availability status of the vehicle 102, a location preference of the driver of the vehicle 102, a ride type preference of the driver, an emergency message indicating the emergency incident, a weather forecast, a pollution status, a seat availability status of a seat in the vehicle 102, a route preference of the driver, a ride discount, a change in a ride fare, a custom status message of the driver, driver information of the driver, vehicle information of the vehicle 102, passenger information of an in-vehicle passenger, and allocation information of the vehicle 102. The targeted content may also include the destination location of the driver, along with one or more intermediate locations from a current location of the driver to the destination location.

The communication device 104 may be configured to display the targeted content to the perspective passengers by means of the displays. In another embodiment, the communication device 104 may be configured to communicate the targeted content by means of the audio devices. The targeted content may be communicated in the one or more languages by means of at least one of the displays and the audio devices. The one or more languages may be determined based on at least one of the location information of the vehicle 102 and the one or more language preferences defined by the driver of the vehicle 102. For example, if the driver prefers “Marathi” language, then the targeted content may be communicated in the “Marathi” language. Similarly, if the location information of the vehicle 102 indicates that the vehicle 102 is in Bengaluru, then the targeted content may be communicated in “Kannada” language, “English” language, or a combination thereof. Further, the targeted content may be displayed using various symbols, colors, fonts, or the like. In addition to the display of the targeted content, the communication device 104 may generate an audio output (or retrieve the audio output from the local or remote database) corresponding to the targeted content and output the targeted content by means of the audio devices. In an embodiment, the communication device 104 may be configured to control activation or deactivation of the displays and the audio devices based on one or more inputs provided by the driver by using the service application running on the driver device 106. Further, the display of the targeted content in the one or more languages may be automatically switched between the displays based on a defined time duration. For example, during a first time duration, a first display of the displays of the communication device 104 may display the targeted content in a first language, and a second display of the displays of the communication device 104 may display the targeted content in a second language. During a second time duration (after completion of the first time duration, the first display of the displays of the communication device 104 may display the targeted content in the second language, and the second display of the displays of the communication device 104 may display the targeted content in the first language.

In some embodiment, the targeted content may correspond to an emergency message corresponding to the emergency incident associated with at least one of the vehicle 102, the driver, or any passenger therein. For example, the emergency message may indicate a break-down, a hijack, a robbery, a medical help, or the like. In one example, the driver or any other passenger in the vehicle 102 may specify or select the emergency message. In another example, the transportation server 114 may be configured to communicate the emergency message based on identification of the emergency incident. In another example, the emergency message may be automatically retrieved from the local or remote database based on identification of the emergency incident by means of the sensor grid 110 including various in-vehicle sensors (such as health sensors, braking sensors, imaging sensors, OBD sensors, or the like). The emergency message may also be automatically retrieved from the local or remote database based on triggering of the emergency switches 108 by the driver or any passenger in the vehicle 102. Thus, the communication device 104 may communicate the emergency incident (i.e., the emergency message) when an occupant of the vehicle 102 such as, the passenger or the driver, triggers the emergency switches 108. In such a scenario, the communication device 104 may be configured to display the emergency message indicating a call for help on its displays. Further, the communication device 104 may be configured to communicate an audio output to indicate the emergency incident or the emergency message associated with the emergency incident. The audio output may be generated in real-time or retrieved from the local or remote database based on the emergency message. In addition to communicating the emergency incident (i.e., the emergency message) by means of the displays and the audio devices, the communication device 104 may be configured to identify one or more near-by rescue entities such as a security officer (e.g., a police officer), a medical officer (e.g., a doctor), or other emergency contacts when a degree of severity of the emergency incident is high priority. Thereafter, the communication device 104 may be configured to communicate the emergency incident along with its priority and an incident location to the near-by rescue entities for availing immediate rescue operations.

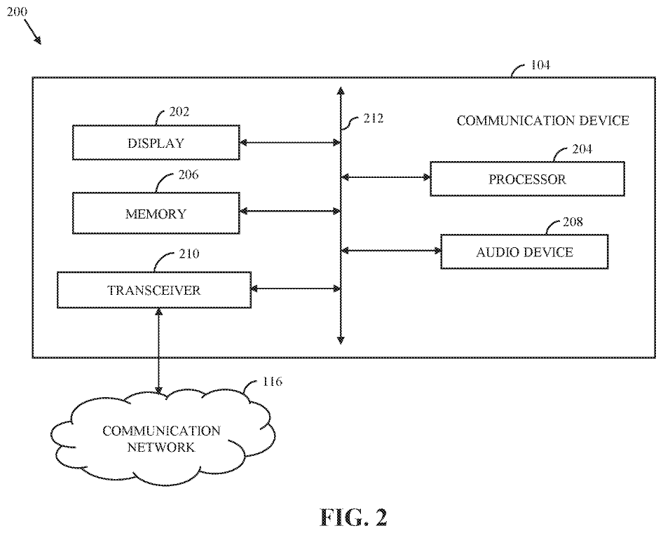

FIG. 2 is a block diagram 200 that illustrates the communication device 104, in accordance with an exemplary embodiment of the disclosure. The communication device 104 includes the displays such as a display 202, a processor 204, a memory 206, the audio devices such as an audio device 208, and a transceiver 210. The display 202, the processor 204, the memory 206, the audio device 208, and the transceiver 210 may be communicatively coupled to each other by way of a communication bus 212.

The display 202 may include suitable logic, circuitry, interfaces, and/or code, executable by the circuitry, that may be configured to perform one or more display operations. For example, the display 202 may be configured to display the targeted content. In an embodiment, the display 202 may be mounted on the outer surface of the vehicle 102, for example, on top of the vehicle 102. Examples of the display 202 include, but are not limited to, an LED display, a thin film transistor liquid crystal display (TFT LCD), an in-plane switching (IPS) LCD, a Resistive Touchscreen LCD, a Capacitive Touchscreen LCD, an organic light emitting diode (OLED), an active-matrix organic light emitting diode (AMOLED), a Super AMOLED, a Retina Display, and a head-up display (HUD). The display 202 may be enclosed in the casing that is designed to avoid direct sunlight onto its display surface. Furthermore, the display 202 may be covered with the smoky acrylic coating that facilitates hiding of the one or more dead pixels on its display surface, thereby, improving the aesthetic view of the display 202.

The processor 204 may include suitable logic, circuitry, interfaces, and/or codes, executable by the circuitry, that may be configured to perform one or more operations for the communication. Examples of the processor 204 may include, but are not limited to, an application specific integrated circuit (ASIC) processor, a reduced instruction set processor (RISC) processor, a complex instruction set computing (CISC) processor, a field programmable gate array (FPGA), a computer processing unit (CPU), a general processing unit (GPU), a neural processing unit (NPU), and a digital signal processor (DSP). It will be apparent to a person skilled in the art that the processor 204 may be compatible with multiple operating systems.

In an embodiment, the processor 204 may be configured to receive the targeted content from the driver device 106 of the driver of the vehicle 102. In another embodiment, the processor 204 may be configured to receive the targeted content from the transportation server 114. In another embodiment, the processor 204 may be configured to retrieve the targeted content from the local or remote database. In another embodiment, the processor 204 may be configured to communicate with the driver device 106 and receive the driver data including the one or more preferences specified by the driver of the vehicle 102. The processor 204 may be further configured to communicate with the emergency switches 108 and receive the emergency control command based on triggering of the emergency switches 108 by the occupant of the vehicle 102. The processor 204 may be further configured to communicate with the sensor grid 110 and receive the sensor data. The processor 204 may be further configured to communicate with the one or more image-capturing devices mounted in the vehicle 102 and receive the image data including the various in-vehicle activities. The processor 204 may be further configured to process at least one of the driver data, the emergency control command, the sensor data, the image data, or the like and generate the targeted content. Post the reception or generation of the targeted content, the processor 204 may communicate the targeted content to by means of the displays (such as the display 202) and/or the audio devices (such as the audio device 208).

In an embodiment, the processor 204 may be further configured to control activation and deactivation of the displays (such as the display 202), and display the targeted content on the display 202 when activated. The processor 204 may be further configured to control activation and deactivation of the audio devices (such as the audio device 208). For example, the audio device 208 may be activated in response to triggering of the emergency switches 108 by the occupant of the vehicle 102.

The memory 206 may include suitable logic, circuitry, interfaces, and/or code, executable by the circuitry, that may be configured to store one or more instructions or code that are executed by the display 202, the processor 204, the audio device 208, and the transceiver 210 to perform their operations. In an exemplary embodiment, the memory 206 may be configured to temporarily manage and store the targeted content. In an exemplary embodiment, the memory 206 may be configured to temporarily manage and store the sensor data. In an exemplary embodiment, the memory 206 may be configured to temporarily manage and store the vehicle information, the driver information, the allocation information, the location information, or the like. Examples of the memory 206 may include, but are not limited to, include a random-access memory (RAM), a read-only memory (ROM), a programmable ROM (PROM), an erasable PROM (EPROM), a removable storage drive, a hard disk drive (HDD), a flash memory, and a solid-state memory. It will be apparent to a person skilled in the art that the scope of the disclosure is not limited to realization of the memory 206 in the communication device 104, as described herein. The memory 206 may be realized in form of a database server or a cloud storage working in conjunction with the communication device 104, without departing from the scope of the disclosure.

The audio device 208 may include suitable logic, circuitry, interfaces, and/or code, executable by the circuitry, that may be configured to perform one or more audio operations. For example, the audio device 208 may be configured to communicate the audio output corresponding to the targeted content. In an embodiment, the audio device 208 may operate in synchronization with the display 202 to communicate the targeted content at the same time.

In one embodiment, the audio device 208 may be mounted on the outer surface of the vehicle 102, for example, at the top of the vehicle 102 or along the sides of the vehicle 102. With such audio device 208 that are external to the vehicle 102, the audio device 208 may communicate the audio output corresponding to the targeted content to notify or alert the people around the vehicle 102. For example, the audio output may be communicated based on triggering or pressing of the emergency switches 108 by the occupant of the vehicle 102. The audio device 208 may communicate the audio output to alert the people around the vehicle 102 in case of the emergency incident associated with at least one of the vehicle 102, the driver, or any passenger therein.

In another embodiment, the audio device 208 may be mounted inside the vehicle 102. With such audio device 208 that are internal to the vehicle 102, the audio device 208 may communicate the audio output corresponding to the targeted content to notify or alert the occupant (i.e., the driver and/or the passenger) of the vehicle 102. For example, the audio output may be communicated based on detection of a failure of a vehicle component of the vehicle 102. The audio device 208 may communicate the audio output to alert the occupant of the vehicle 102 of the emergency incident. Examples of the audio device 208 may include, but are not limited to, audio speakers such as a mono speaker, a stereo speaker, or the like.

The transceiver 210 may include suitable logic, circuitry, interfaces, and/or code, executable by the circuitry, that may be configured to provide a platform or a medium for communication between various devices or servers. The transceiver 210 may be configured to allow the communication device 104 to transmit (or receive) data to (or from) various servers or devices, such as the driver device 106, the emergency switches 108, the sensor grid 110, and the transportation server 114 via the communication network 116. For example, the transceiver 210 may be configured to receive the targeted content from the driver device 106 or the transportation server 114. Examples of the transceiver 210 may include, but are not limited to, an antenna, a radio frequency transceiver, a wireless transceiver, and a Bluetooth transceiver. The transceiver 210 may facilitate the communication platform or medium using various wired and wireless communication protocols, such as TCP/IP, UDP, LTE communication protocols, or any combination thereof.

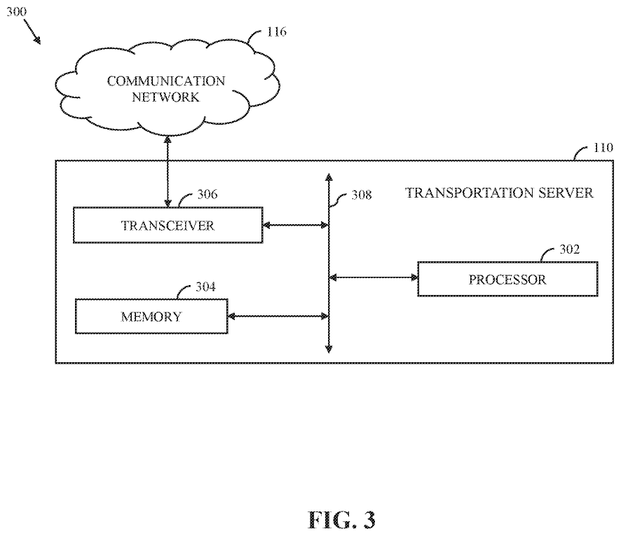

FIG. 3 is a block diagram 300 that illustrates the transportation server 114, in accordance with an exemplary embodiment of the disclosure. The transportation server 114 includes a processor 302, a memory 304, and a transceiver 306. The processor 302, the memory 304, and the transceiver 306 may communicate with each other by way of a communication bus 308.

The processor 302 may include suitable logic, circuitry, interfaces, and/or code, executable by the circuitry, that may be configured to perform one or more operations. Examples of the processor 302 may include, but are not limited to, an ASIC processor, a RISC processor, a CISC processor, an FPGA, a CPU, a GPU, an NPU, and a DSP. It will be apparent to a person of ordinary skill in the art that the processor 302 may be compatible with multiple operating systems.

In an embodiment, the processor 302 may be configured to communicate with the driver device 106 and receive the driver data including the one or more preferences specified by the driver of the vehicle 102. The processor 302 may be further configured to communicate with the emergency switches 108 and receive the emergency control command based on triggering of the emergency switches 108 by the occupant of the vehicle 102. The processor 302 may be further configured to communicate with the sensor grid 110 and receive the sensor data. The processor 302 may be further configured to communicate with the one or more image-capturing devices mounted in the vehicle 102 and receive the image data including the various in-vehicle activities. The processor 302 may be further configured to process at least one of the driver data, the emergency control command, the sensor data, the image data, or the like and generate the targeted content. The processor 302 may be further configured to communicate the targeted content to the communication device 104.

The memory 304 may include suitable logic, circuitry, interfaces, and/or code, executable by the circuitry, that may be configured to store one or more instructions or code that are executed by the processor 302 and the transceiver 306 to perform their operations. In an exemplary embodiment, the memory 304 may be configured to temporarily manage and store the account profile of each registered driver and the account profile of each registered passenger. In an exemplary embodiment, the memory 304 may be configured to temporarily manage and store the allocation information of each vehicle such as the vehicle 102. In an exemplary embodiment, the memory 304 may be configured to temporarily manage and store the driver data, the emergency control command, the sensor data, the image data, or the like. In an exemplary embodiment, the memory 304 may be configured to temporarily manage and store the targeted content. Examples of the memory 304 may include, but are not limited to, a RAM, a ROM, a PROM, an EPROM, a removable storage drive, an HDD, a flash memory, and a solid-state memory. It will be apparent to a person skilled in the art that the scope of the disclosure is not limited to realization of the memory 304 in the transportation server 114, as described herein. The memory 304 may be realized in form of a database server or a cloud storage working in conjunction with the transportation server 114, without departing from the scope of the disclosure.

The transceiver 306 may include suitable logic, circuitry, interfaces, and/or code, executable by the circuitry, that may be configured to provide a platform or a medium for communication between various devices or servers. The transceiver 306 may be configured to allow the transportation server 114 to transmit (or receive) data to (or from) various servers or devices, such as the communication device 104, the driver device 106, the emergency switches 108, and the sensor grid 110 via the communication network 116. For example, the transceiver 306 may be configured to transmit the targeted content to the communication device 104. Examples of the transceiver 306 may include, but are not limited to, an antenna, a radio frequency transceiver, a wireless transceiver, and a Bluetooth transceiver. The transceiver 306 may facilitate the communication platform or medium using various wired and wireless communication protocols, such as TCP/IP, UDP, LTE communication protocols, or any combination thereof.

FIG. 4A is a diagram 400A that illustrates a top view of the vehicle 102, in accordance with an exemplary embodiment of the disclosure. The vehicle 102 includes the driver device 106, the emergency switches 108 such as an emergency SOS tab or button 108a, and the audio device 208 such as audio devices 208a-208h.

The driver device 106 may be mounted in the interior of the vehicle 102 to enable the driver of the vehicle 102 to operate the installed service application. For example, the driver device 106 may be mounted on a dashboard of the vehicle 102. In another example, when the driver device 106 is a mobile device of the driver, the driver may mount the driver device 106 on a front wind shield of the vehicle 102. The emergency switches 108 may also be mounted in the interior of the vehicle 102. Each of the emergency switches 108 may be used by the occupant of the vehicle 102 such as, the driver or the passenger of the vehicle 102, to activate the emergency switches 108 when the occupant experiences any safety concern in the vehicle 102. In one example, each of the emergency switches 108 may be mounted on an arm rest adjacent to each seat of the vehicle 102. In another example, each of the emergency switches 108 may be implemented as a software-based emergency SOS tab (as shown in FIG. 5) that is facilitated by means of the service application.

In an embodiment, the audio devices 208a-208f may be mounted on the exterior of the vehicle 102 to alert the people around the vehicle 102. For example, the audio devices 208a-208d may be mounted along exterior sides of the vehicle 102, as shown in the FIG. 4A. Further, the audio devices 208e and 208f may be mounted on front and back portions of the vehicle 102, as shown in the FIG. 4A. In another example, the audio devices 208g-208h may be mounted in the interior of the vehicle 102. In one example, the audio devices 208a-208f may be turned ON to output the audio output based on triggering of the emergency switches 108 by the occupant of the vehicle 102. In another example, the audio devices 208a-208f may be turned ON to output the audio output based on the heath condition of the vehicle 102, the driver, or the passenger therein.

It will be apparent to a person skilled in the art that the scope of the disclosure is not limited to installation of the driver device 106, the emergency switches 108, and the audio devices 208a-208h as shown in FIG. 4A. In various other embodiments, any of the driver device 106, the emergency switches 108, and the audio devices 208a-208h may be installed or mounted at various positions other than illustrated in FIG. 4A, without limiting the scope of the disclosure.

FIG. 4B is a diagram 400B that illustrates a side view of the displays, such as displays 202a and 202b, of the communication device 104, in accordance with an exemplary embodiment of the disclosure. The displays 202a and 202b may be mounted on the top of the vehicle 102. The displays 202a and 202b may be enclosed inside a case 402 such that exposure to the direct sunlight may be avoided. With the prolonged use of the displays 202a and 202b, various electronic parts such as in-build transistors inside the displays 202a and 202b may malfunction or stop working. Additionally, manufacturing defects of the displays 202a and 202b may also result in damaging the transistors. With all this, the dead pixels may prevail in each display 202a or 202b that can decrease the aesthetics of the display 202a or 202b. Thus, the displays 202a and 202b may be covered with the smoky acrylic coating 404 that facilitates hiding of the dead pixels on the displays 202a and 202b, which in turn improves the aesthetics of the displays 202a and 202b.

FIG. 4C is a diagram 400C that illustrates a front view of the vehicle 102 including the display 202a of the communication device 104, in accordance with an exemplary embodiment of the disclosure. The front view shows the case 402 enclosing the display 202a. The display 202a, as shown, may be mounted on the top surface of the vehicle 102.

FIG. 5 is a block diagram 500 that illustrates a user interface 502 rendered on the driver device 106 of the driver of the vehicle 102, in accordance with an exemplary embodiment of the disclosure. The transportation server 114 may be configured to render the user interface 502 on the driver device 106 by means of the service application via the communication network 116. The user interface 502 may be configured to present the emergency switches 108 (such as an emergency SOS tab or button 108b), a first preference section 504, and a submit tab 506.

The emergency SOS tab 108b may be a software-based emergency SOS tab that is facilitated by means of the service application running on the driver device 106. The emergency SOS tab 108b may enable the driver of the vehicle 102 to trigger an emergency signal corresponding to the emergency incident in an event of a safety concern. Thus, when the driver triggers the emergency SOS tab 108b, the driver device 106 (or the service application running on the driver device 106) may transmit the emergency control command directly to the communication device 104 or the transportation server 114. Based on the emergency control command, the communication device 104 (or the transportation server 114) may activate (i.e., turn ON) the display 202 (such as the displays 202a and 202b) and the audio device 208 (such as the audio devices 208a-208h) and communicate the emergency message, such as “HELP”, by means of the display 202 and the audio device 208. In one example, in response to triggering of the emergency SOS tab 108b, the service application may prompt the driver to provide a type of the emergency incident. The type of the emergency incident may correspond to at least one of a medical emergency (for example, an injury to the occupant in case of an accident of the vehicle 102, heart attack, or the like), a criminal emergency (for example, a hijack, a robbery, or the like), or a vehicle-breakdown emergency. Based on the type of the emergency incident, the driver device 106 (or the service application) may be further configured to transmit another control command to the communication device 104 for displaying the emergency message corresponding to the type of the emergency incident. For example, when the driver indicates the type of the emergency incident to be the medical emergency, the processor 204 may be configured to display “MEDICAL EMERGENCY” message on the displays 202a and 202b. In a scenario where the driver does not provide the type of the emergency incident for a defined time period, the driver device 106 (or the service application) may automatically communicate a control command to the communication device 104 for displaying the emergency message, such as “HELP” on the displays 202a and 202b. The processor 204 may be further configured to activate the audio devices 208a-208h to communicate the audio output corresponding to the emergency message to alert the people around the vehicle 102.

The first preference section 504 may enable the driver to specify the one or more preferences for the targeted content. The first preference section 504 may include a vehicle type preference option, a location preference option, a route preference option, and a discount preference option. The vehicle type preference option may be indicated by a set of radio buttons. Each radio button may indicate a type of a vehicle service currently being offered by the driver of the vehicle 102. For example, the set of radio buttons may include a first radio button 508a that indicates the vehicle type to be an individual ride vehicle and offers rides on individual-basis. The set of radio buttons may further include a second radio button 508b that indicates the vehicle type to be a share-ride vehicle and offers rides on sharing-basis.

The location preference option may include a location drop-down list 510 that may enable the driver to indicate a preference for the location (for example, the destination of the driver i.e., a home location). In an embodiment, the location drop-down list 510 may allow the driver to select only one location as the preferred location. In another embodiment, the location drop-down list 510 may allow the driver to select multiple locations (for example, the one or more intermediate locations between the current location and the destination location) as preferred locations.

The route preference option may include a route drop-down list 512 that enables the driver to indicate a preference for one or more routes. In an embodiment, the route drop-down list 512 may allow the driver to select only one route as a preferred route. In another embodiment, the route drop-down list 512 may allow the driver to select multiple routes (for example, corresponding to the one or more intermediate locations) as preferred routes. The discount preference option may include a discount drop-down list 514 that enables the driver to indicate a preference for a ride discount which the driver wishes to offer to the prospective passengers. Additionally, the first preference section 504 may also include other options (such as a language preference option) that enables the driver to indicate a preference for the one or more languages for communicating the targeted content. The submit tab 506 may enable the driver to submit the one or more preferences. The driver device 106 (or the service application installed therein) may communicate the one or more preferences of the driver to the communication device 104 or the transportation server 114 via the communication network 116.

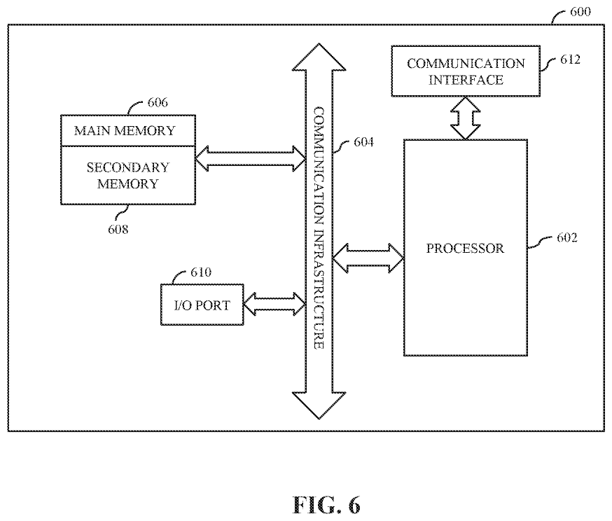

FIG. 6 is a block diagram that illustrates a system architecture of a computer system 600 for communicating the targeted content to one or more users, in accordance with an exemplary embodiment of the disclosure. An embodiment of the disclosure, or portions thereof, may be implemented as computer readable code on the computer system 600. In one example, the communication device 104 or and the transportation server 114 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components of FIGS. 2 and 3.

The computer system 600 may include a processor 602 that may be a special purpose or a general-purpose processing device. The processor 602 may be a single processor, multiple processors, or combinations thereof. The processor 602 may have one or more processor “cores.” Further, the processor 602 may be connected to a communication infrastructure 604, such as a bus, a bridge, a message queue, the communication network 116, multi-core message-passing scheme, and the like. The computer system 600 may further include a main memory 606 and a secondary memory 608. Examples of the main memory 606 may include RAM, ROM, and the like. The secondary memory 608 may include a hard disk drive or a removable storage drive (not shown), such as a floppy disk drive, a magnetic tape drive, a compact disk, an optical disk drive, a flash memory, and the like. Further, the removable storage drive may read from and/or write to a removable storage device in a manner known in the art. In an embodiment, the removable storage unit may be a non-transitory computer readable recording media.

The computer system 600 may further include an input/output (I/O) port 610 and a communication interface 612. The I/O port 610 may include various input and output devices that are configured to communicate with the processor 602. Examples of the input devices may include a keyboard, a mouse, a joystick, a touchscreen, a microphone, and the like. Examples of the output devices may include a display screen, a speaker, headphones, and the like. The communication interface 612 may be configured to allow data to be transferred between the computer system 600 and various devices that are communicatively coupled to the computer system 600. Examples of the communication interface 612 may include a modem, a network interface, i.e., an Ethernet card, a communications port, and the like. Data transferred via the communication interface 612 may be signals, such as electronic, electromagnetic, optical, or other signals as will be apparent to a person skilled in the art. The signals may travel via a communications channel, such as the communication network 116 which may be configured to transmit the signals to the various devices that are communicatively coupled to the computer system 600. Examples of the communication channel may include, but not limited to, cable, fiber optics, a phone line, a cellular phone link, a radio frequency link, a wireless link, and the like.

Computer program medium and computer usable medium may refer to memories, such as the main memory 606 and the secondary memory 608, which may be a semiconductor memory such as dynamic RAMs. In an embodiment, the disclosure is implemented using a computer implemented application. The computer implemented application may be stored in a computer program product and loaded into the computer system 600 using the removable storage drive or the hard disk drive in the secondary memory 608, the I/O port 610, or the communication interface 612.

Various embodiments of the disclosure provide the communication device 104 for communicating the targeted content to the prospective passengers or passer-by individuals. The communication device 104 may include one or more displays and/or audio devices (such as the displays 202a and 202b and the audio devices 208a-208h) for communicating the targeted content to the prospective passengers or passer-by individuals. The communication device 104 may be the computing device that is communicatively coupled with the communication network 116 for performing one or more operations, such as receiving, processing, and communicating the targeted content associated with the vehicle 102. The communication device 104 may be configured to receive the targeted content from the driver device 106. The communication device 104 may be further configured to process the targeted content. The communication device 104 may be further configured to display the targeted content on the displays (such as the displays 202a and 202b) that are mounted on the top of the vehicle 102. In another embodiment, the communication device 104 may be configured to receive the targeted content from the transportation server 114 and display the targeted content on the displays (such as the displays 202a and 202b). In another embodiment, the communication device 104 may be configured to retrieve the targeted content from a local database (e.g., from its own memory) or a remote database (e.g., from a database server) and display the targeted content on the displays (such as the displays 202a and 202b).

Various embodiments of the disclosure provide a non-transitory computer readable medium having stored thereon, computer executable instructions, which when executed by a computer, cause the computer to execute operations for performing the communication of the targeted content by means of the one or more displays and/or audio devices (such as the displays 202a and 202b and the audio devices 208a-208h). The operations include receiving, by the communication device 104, the targeted content from the driver device 106 or the transportation server 114. The targeted content may include at least one of the availability status of the vehicle 102, the location preference of the driver of the vehicle 102, the ride type preference of the driver, the emergency message indicating the emergency incident, the weather forecast, the pollution status, the seat availability status of the seat in the vehicle 102, the route preference of the driver, the ride discount, the change in the ride fare, the custom status message of the driver, the driver information of the driver, the vehicle information of the vehicle 102, the passenger information of the in-vehicle passenger, and the allocation information of the vehicle 102. The targeted content may also include the destination location of the driver, along with the one or more intermediate locations from the current location of the driver to the destination location. The operations further include processing, by the communication device 104, the targeted content. The operations further include displaying, by the communication device 104, the targeted content to the prospective passengers.

The disclosed embodiments encompass numerous advantages. The disclosure provides the communication method and system for facilitating effective and efficient communication of the targeted content to various prospective passengers or other individuals who are outside the vehicle 102. The communication device 104 includes a smart LED display which not just helps in the communication but also in the entire mobility experience for drivers, passengers, and vehicles around. The communication device 104 is designed to avoid direct sunlight on its display (such as the displays 202a and 202b) that facilitates increased aesthetic view of each display (such as the displays 202a and 202b). Furthermore, the communication device 104 is positioned on the top of the vehicle 102, facing forward and backward for the best all-round visibility. Furthermore, the communication device 104 aids kerbside shared hailing and thus facilitating an extra income for the same distance. Furthermore, a prospective passenger can easily determine whether an approaching vehicle (such as the vehicle 102) is available for hiring or not. The disclosure further facilitates hassle free denials of rides when a driver of the approaching vehicle has own location preference for new rides. The disclosure further facilitates hassle free denials of rides when the driver of the approaching vehicle is heading back to home or is engaged in some personal activities. Furthermore, the communication device 104 of the disclosure may be used to alert the near-by individuals for help in case of the emergency incident.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

While various embodiments of the disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

What is claimed is:

1. A communication system comprising:
a communication device communicatively coupled to a driver device of a driver of a vehicle and a transportation server associated with a vehicle service provider that offers on-demand vehicle services to passengers in a geographical region, the communication device comprising:
a plurality of displays mounted on an outer surface of the vehicle,
wherein each display includes a smoky acrylic covering for hiding one or more dead pixels associated with each display; and
a processor communicatively coupled to the plurality of displays, wherein the processor is configured to:
receive targeted content associated with the vehicle from at least one of the driver device or the transportation server, and
display the targeted content on the plurality of displays.

2. The communication system of claim 1, wherein the targeted content includes at least one of a vehicle availability status of the vehicle for a ride, a seat availability status of a seat in the vehicle for the ride, a ride discount for the ride, a change in a ride fare for the ride, a vehicle rating of the vehicle, vehicle information of the vehicle, and allocation information of the vehicle.

3. The communication system of claim 1, wherein the targeted content includes a destination location of the driver, along with one or more intermediate locations from a current location of the driver to the destination location.

4. The communication system of claim 1, wherein the targeted content includes at least one of a location preference of the driver, a ride type preference of the driver, a route preference of the driver, a driver rating of the driver, a custom status message of the driver, and driver information of the driver.

5. The communication system of claim 1, wherein the targeted content includes at least one of a weather forecast and a pollution status associated with a current location of the vehicle.

6. The communication system of claim 1, wherein the targeted content includes at least an emergency incident associated with the vehicle, the driver, or a passenger of the vehicle.

7. The communication system of claim 6, further comprising one or more emergency switches in the vehicle that are communicatively coupled to the communication device for communicating the emergency incident when the driver or the passenger presses the one or more emergency switches.

8. The communication system of claim 6, further comprising one or more sensors in the vehicle that are communicatively coupled to the communication device for communicating the emergency incident when the one or more sensors automatically detect one or more anomalies associated with at least one of the vehicle, the driver, or the passenger.

9. The communication system of claim 1, wherein the processor is further configured to display the targeted content on the plurality of displays in a plurality of languages, respectively, wherein the display of the targeted content in the plurality of languages are automatically switched between the plurality of displays based on a defined time duration.

10. The communication system of claim 9, wherein the processor is further configured to determine the plurality of languages based on at least location information of the vehicle and a language preference of the driver.

11. The communication system of claim 10, wherein a service application running on the driver device is used by the driver to communicate one or more preferences to the communication device, wherein the one or more preferences are associated with at least the targeted content and one or more languages preferred by the driver for displaying the targeted content on the communication device.

12. The communication system of claim 1, wherein the communication device further includes a first set of audio devices for communicating an audio output corresponding to the targeted content.

13. The communication system of claim 12, wherein the first set of audio devices is mounted on the outer surface of the vehicle.

14. The communication system of claim 12, wherein the processor is further configured to control activation or deactivation of the plurality of displays and the first set of audio devices based on one or more inputs provided by the driver by using a service application running on the driver device.
